(19) United States
(12) Patent Application Publication
(10) Pub. No.: US 2017/0158167 A1
(43) Pub. Date: Jun. 8, 2017

(54) WHEEL - B - STEEL

(71) Applicant: Eul Eusan Speed, Fort Worth, TX (US)

(72) Inventor: Eul Eusan Speed, Fort Worth, TX (US)

(73) Assignee: Eul Eusan Speed, Fort Worth, TX (US)

(21) Appl. No.: 14/959,096

(22) Filed: Dec. 4, 2015

(51) Int. Cl. B60R 25/09; B60T 3/00; B60B 7/16; B60T 1/00

(52) U.S. Cl. CPC B60R 25/09; B60T 1/005; B60T 3/00; B60B 7/16

(57) ABSTRACT

The invention provides theft prevention for wheels and cars. There is no other product of its kind only the regular wheel boot that the city puts on cars for traffic ticket violations. The devices has two metal bars with hooks that attach behind the wheel and a metal plate that covers the wheel lug nuts one of the metal bars extend out longer than the other one and is used to stop the wheel from turning. The overall function of the device is to stop car and wheel theft.

Wheel-B-Steel is a device that goes on 20″ and up luxury wheels to keep it from being stolen. The device covers all of the lug nuts on any wheel were the nuts cannot be removed. The device also has a bar that goes up into to the axle of the car so the car cannot be stolen or moved from its location, the wheels will not turn once the device is securely put on. The device has two functions you cannot remove the wheel from a car and you cannot steal the car so the wheels can be taken off once it has been moved to a secure location. With wheel and car theft being very high in society Wheel-B-Steel will be a helpful tool to stop car and wheel theft.

I Eul E. Speed has invented a new product WHEEL-B-STEEL as set forth in the following:

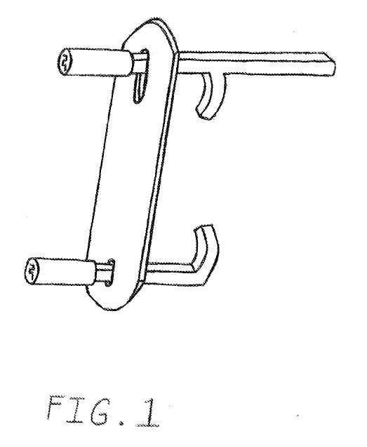

FIG. 1 is an isometric view of WHEEL-B-STEEL showing my new product;

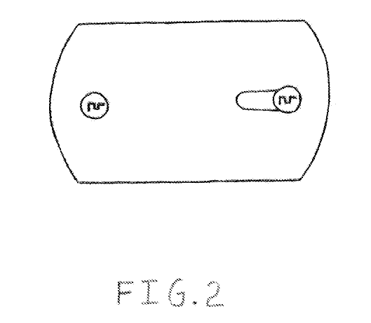

FIG. 2 is a top view thereof;

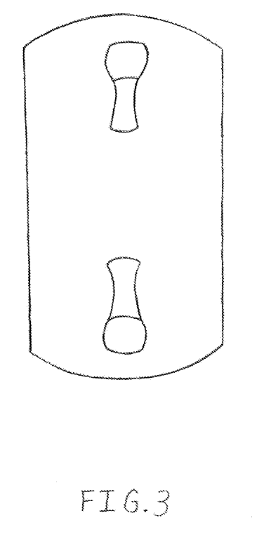

FIG. 3 is a bottom view thereof;

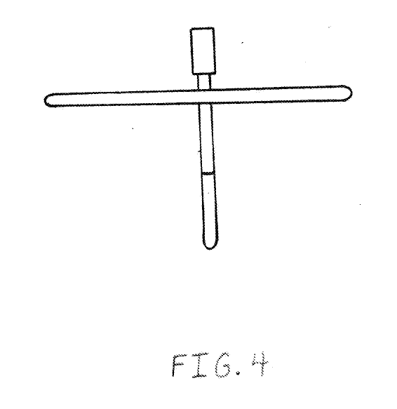

FIG. 4 is a front view thereof;

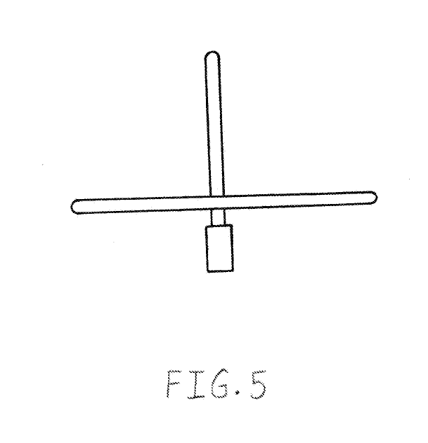

FIG. 5 is a rear view thereof;

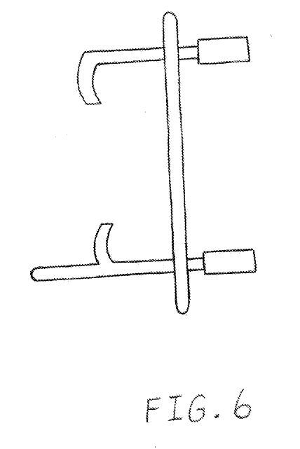

FIG. 6 is a left side view thereof;

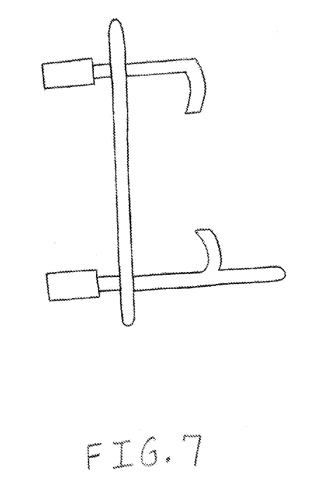

FIG. 7 is a right side view thereof;

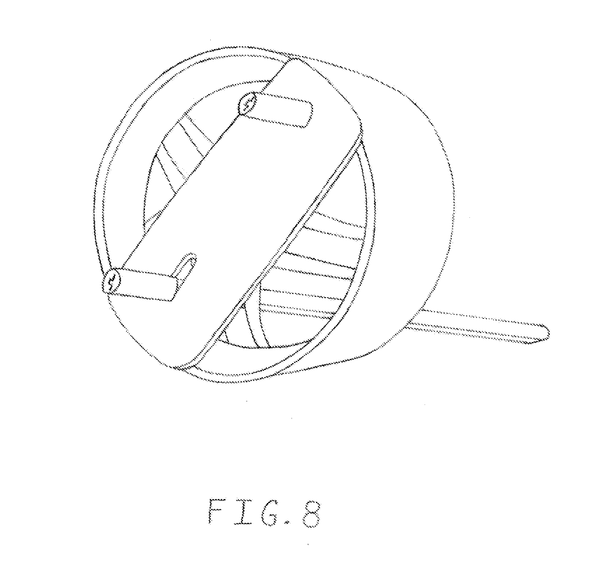

FIG. 8 is an isometric view of WHEEL-B-STEEL assembled on a wheel thereof;

1. WHEEL-B-STEEL prevents theft of wheels by covering the lug nuts were they cannot be removed.

2. WHEEL-B-STEEL prevents car theft, the devices has a long bar that go up into the axle of a car and the wheel cannot make a full turn.
